(19) United States
(12) Patent Application Publication
(10) Pub. No.: US 2010/0293093 A1
(43) Pub. Date: Nov. 18, 2010

(54) Alterable Security Value

(76) Inventor: Igor Karpenko, Sunnyvale, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/574,636

(22) Filed: Oct. 6, 2009

Related U.S. Application Data
(60) Provisional application No. 61/177,869, filed on May 13, 2009.

(51) Int. Cl. G06Q 20/00; G06Q 40/00; G06F 15/16

(52) U.S. Cl. 705/41; 705/44; 709/204

(57) ABSTRACT

Handling of verification values for portable consumer payment devices is disclosed. A verification value can be generated and associated with a portable payment device. The verification value can serve to supplement the conventional verification value that is printed on the portable payment device in order to provide an additional level of security against fraudulent use. When the portable payment device is used for a qualifying transaction, the generated verification value can be used to verify or authenticate the transaction instead of or in addition to the conventional verification value printed on the portable payment device.

### CROSS-REFERENCES TO RELATED APPLICATIONS

The present application is a non-provisional of and claims priority to U.S. Non-Provisional Application No. 61/177,869, filed on May 13, 2009, the entire contents of which are herein incorporated by reference for all purposes.

### BACKGROUND

Portable payment devices such as credit cards and debit cards utilize security features known generally in the industry as a Card Verification Value (CVV) to increase protection against fraudulent use. CVVs are variously referred to in the industry Card Security Code (CSC), Card Verification Value Code (CVVC), Card Verification value (CVC), or Verification value (V-Code or V Code), and may be referred to in this disclosure by these terms as well as “verification value” and verification code.” There are two types of verification values. The first, called CVC1 or CVV1, is encoded on the magnetic stripe of the portable payment device. The second, called CVC2 or CVV2, is printed on the portable payment device.

The CVV1 code is used for “in person” transactions, where the consumer of the payment device is physically present at the time of purchase. The consumer hands the merchant the portable payment device, who then swipes it through a point of sale terminal. Information stored on the magnetic stripe, including the CVV1 code, is read from the magnetic stripe and transmitted in a purchase transaction for verification (authentication).

However, transactions over the Internet, by mail, fax or over the phone cannot be verified using the CVV1 code. For these so-called “card not present” (CNP) transactions, the merchant will use the CVV2 code to authenticate the purchase by asking the consumer to read aloud the code. The CVV2 code is used to authenticate the purchase transaction by comparing the code supplied by the consumer against the code that is stored in a cardholder database at a payment processor facility. If the purchase transaction is authenticated, then an authorization request is sent to the issuer of the card to approve or deny the purchase.

FIGS. 8A and 8B illustrate typical portable payment devices. FIG. 8A illustrates an instance of a portable payment device 800, showing the front side of the portable payment device. Various indicia are printed, embossed, or otherwise affixed to the card 802, including a primary account number (PAN) 812, a name 808 that identifies the cardholder, an expiration date of the portable payment device 810, and a logo or other graphic 806 that identifies the issuer of the portable payment device. The issuer may be bank, for example. Although not shown in the figure, typically a logo of the financial payment network or payment processing network (e.g., Visa, MasterCard, etc.) is also provided. A security feature 804 may be included on the card 802 to distinguish counterfeits. The instance of the portable payment device 800 shown in FIG. 8A includes a CVV2 code 814 that is printed on the front side of the card 802.

FIG. 8B shows the back side of another instance of portable payment device 800. Here, the typical features include a magnetic stripe 822 and a signature box 824.

The portable payment device 800 shown in this figure is configured with a CVV2 code 814′ printed on the back side of the card 802.

More than half of all electronic payment disputes are fraud related, the majority of which are for card not present (CNP) transactions such as Internet-based purchases. As the volume of Internet transactions grow, an increase in the number of fraudulent transactions is expected. Internet-based merchants' Web sites rely on Card Verification Value 2 (CVV 2) on the back (or front) of the card to reduce fraud, but even this number can be stolen and later used in fraudulent transactions.

These and other problems are addressed by embodiments of the invention, individually and collectively.

### BRIEF SUMMARY

Embodiments of the invention provide a temporary security value with which a transaction can be conducted. The temporary security value is used to authenticate (verify, validate) the transaction when the transaction meets (satisfies or qualifies under) one or more conditions.

Embodiments of the invention provide a temporary security value used to authenticate qualified transactions, where the temporary security value has a limited period of time within which it must be used. Embodiments of the invention provide a temporary security value used to authenticate qualified transactions, where the temporary security value can be used only once.

Embodiments of the invention include a method for authenticating a transaction such as a purchase of a good or service using a temporary security value.

Embodiments of the invention include providing a temporary security value in a portable payment device serves to supplement a predefined security value that is associated with the portable payment device in order to provide an additional level of security against fraud.

These and other embodiments of the invention are explained in further detail.

### BRIEF DESCRIPTION OF THE DRAWINGS

FIG. 1 is a block diagram illustrating an embodiment of the invention showing a sign up process.

FIG. 2 is a flow illustrating sign up processing in accordance with an embodiment of the invention.

FIG. 3 is a block diagram illustrating an embodiment of the invention showing the flow for a transaction.

FIG. 4 is a flow illustrating generation and use of a temporary security value in accordance with an embodiment of the invention.

FIG. 5A is a flow illustrating processing of a transaction in accordance with an embodiment of the invention.

FIG. 5B is a flow illustrating processing of a transaction in accordance with another embodiment of the invention.

FIG. 6 is a block diagram illustrating an embodiment of the invention showing an exception processing flow.

FIG. 7 is a block diagram of a computer apparatus for embodiments of the invention.

FIGS. 8A and 8B show examples of typical portable payment devices.

### DETAILED DESCRIPTION

For purposes of this application, the term “payment device” can mean an easily portable device which may be used in a transaction as described herein. Without limiting the generality of the foregoing, “payment device” can include a device in the form of a card such as a magnetic stripe card, an integrated circuit card (also commonly known as a smartcard), a memory card, etc. The payment device may also be in the form of a credit card, debit card, stored value card, prepaid card, etc.

An embodiment of the invention provides a service that can allow a holder of payment device to:
Obtain a one-time-use, or temporary CVV2 value or other security value, in real time. This temporary security value can be “short-lived”, e.g., it will have to be used by the cardholder within a predetermined number of minutes (e.g., 5 minutes or less) and it can only be used once. Typical time limits may be on the order of 10 to 15 minutes or less. It is understood, of course, that any time limit can be specified. The time limit sets an expiration time, before which the one-time-use CVV2 value must used.
Create rules that require qualifying transactions to be allowed only if the one-time-use CVV2 value is used. For example, the cardholder can specify that all ECMOTO (electronic commerce mail order telephone) transactions above $100 must be authenticated using the one-time-use CVV2 value. Qualifying transactions that are submitted with the one-time-use CVV2 value obtained from the back of the card will be declined. Qualifying transactions (e.g., purchases) are those transactions that match one or more of the rules defined by the cardholder.

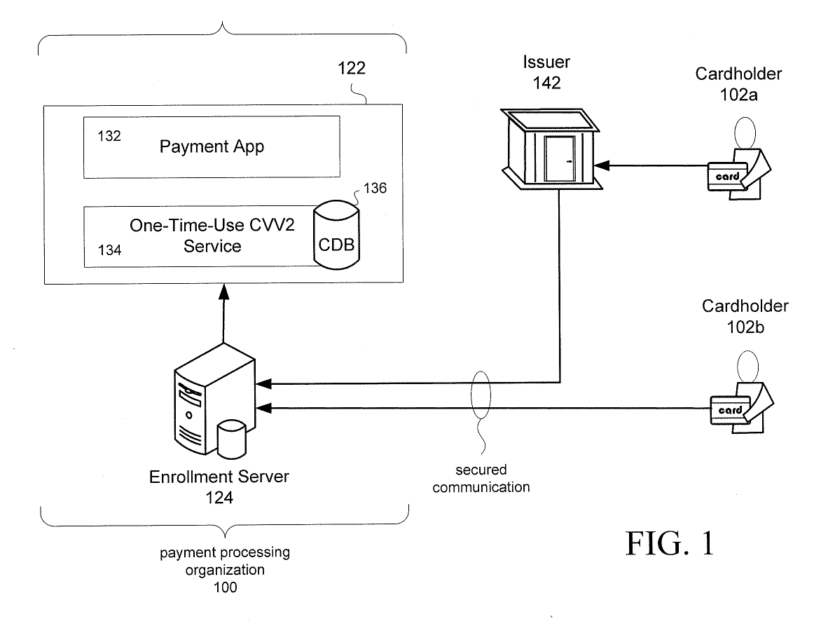

FIG. 1 shows a payment processing organization 100 that provides authorization, clearing, and settlement services. The payment processing organization 100 manages and operates a payment processing system 122 and an enrollment server 124 in accordance with an embodiment of the invention. The payment processing system 122 provides services in accordance with an embodiment of the invention. The figure shows in particular a registration process for registering with the payment processing system 122. The payment processing system 122 includes a payment application component 132 and a one-time-use CVV2 service component 134, and maintains a cardholder database (CDB) 136 to store information that is used by the payment application component and the one-time-use CVV2 service component. The elements 132, 134, 136 of the payment processing system 122 may comprise one or more computer devices interconnected by suitable communication lines, and executing suitable configured program code to perform data operations in accordance with an embodiment of the invention. Additional details of the elements 132, 134, 136 will be given below.

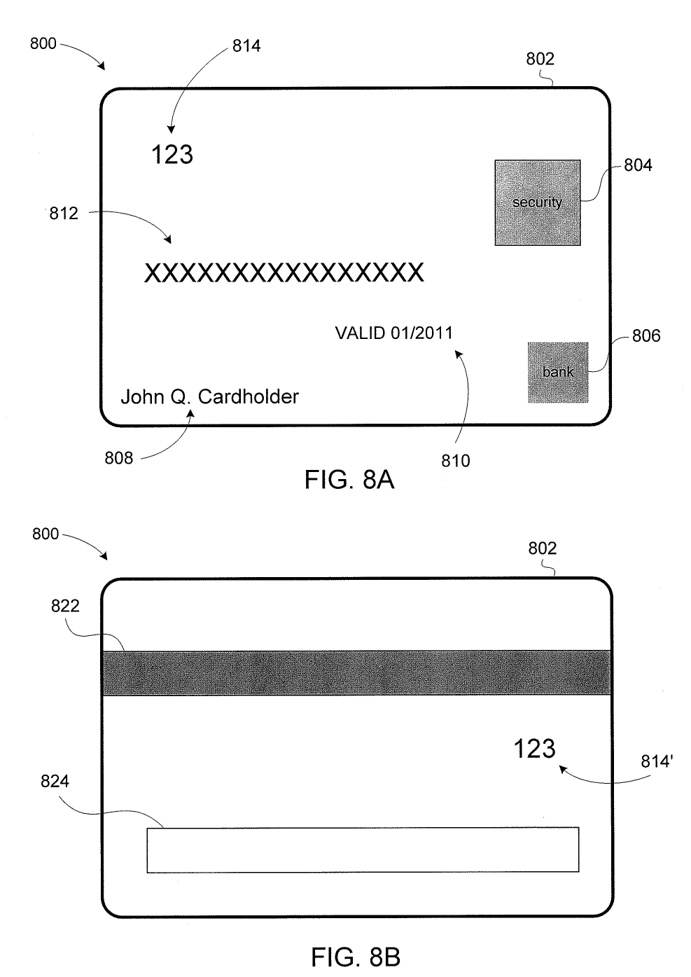

FIG. 1 shows that cardholder users 102a, 102b can interact with a payment processing system 122 in two ways: A cardholder 102a can interact with the payment processing system 122 via an issuer 142. A cardholder 102b can interact with the payment processing system 122 via the enrollment server 124. The issuer 142, which may be an entity such as a bank, issues payment devices; e.g., credit cards. The payment device may be provided with a pre-printed CVV2 value (referred to herein as “the printed CVV2 code”), either on the front of the device or on the back as shown for example in FIGS. 8A and 8B. It will be understood that there can be more than one issuer 142, one for each kind of payment device.

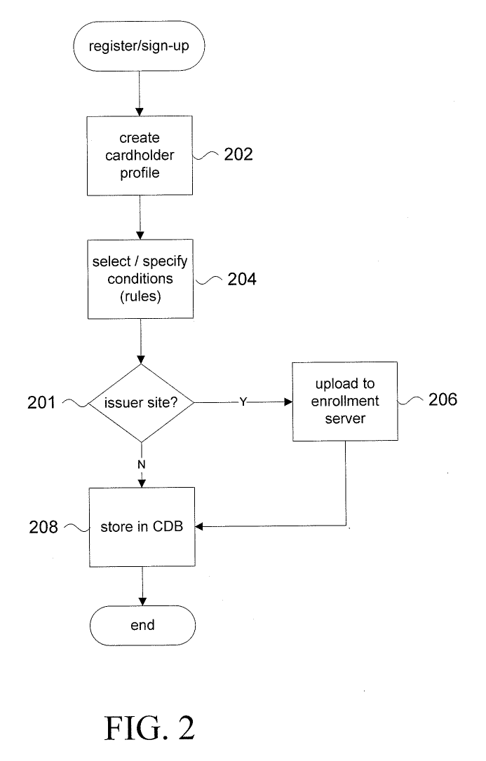

FIG. 2 illustrates steps in a registration (sign up) process in accordance with an embodiment of the invention, and is explained in conjunction with FIG. 1. As can be seen in FIG. 1, cardholder can register with the payment processing system 122 in order to access services relating to the one-time-use CVV2 value of the invention. A cardholder, such as cardholder 102a, can register via the issuer 142. For example, the cardholder can register in person at a facility provided by the issuer 142. For example, if the issuer 142 is a bank, the bank may have one or more branch offices. The cardholder can visit one of the bank's branch offices, walk up to a teller or some other representative of the bank and conduct the registration process with that person. The issuer 142 may have an ATM or other kiosk at the branch office or at other locations such as in a shopping mall, where the cardholder may interact with ATM or kiosk to conduct the registration process. The issuer 142 may host a web site that cardholders can access using a personal computer or a mobile device to conduct the registration process via a web browser. From the foregoing, it can be appreciated that the issuer 142 can provide these and other means by which a cardholder can conduct the registration process.

FIG. 1 also shows that a cardholder such as cardholder 102b can access the payment processing system 122 directly to conduct the registration process. For example, a web site hosted by the payment processing organization 100 on the enrollment server 124 can allow cardholders to access the enrollment server using a personal computer or a mobile device to conduct the registration process via a web browser. The cardholder's access to the enrollment server 124 can be provided over the Internet. Communications with the enrollment server 124 can be secured using known secured protocol standards to protect the cardholder's confidential information provided during the registration process. In an embodiment, the connection is encrypted, e.g., using SSL 3.0 (secured sockets layer, 3.0).

Referring to FIG. 2, as part of the registration process, the cardholder creates a cardholder profile (step 202). The cardholder can provide his account number(s) for each payment device, to be stored as part of the cardholder's profile. The cardholder can be given an option to define aliases for his accounts to facilitate identifying his accounts (it is easier to remember an alias than a sixteen-digit card number). For example, the cardholder may have an account for his business to which he might assign an alias such as “the store” and an account for home purchases to which he might assign an alias such as “the house.” Any aliases the cardholder might define can be stored in the cardholder's profile. The cardholder's profile can include one or more “rules” for triggering the one-time-use CVV2 service provided in accordance with an embodiment of the invention.

Thus, in step 204, the cardholder can select or otherwise specify one or more rules (conditions, criteria) under which participation in the one-time-use CVV2 service is desired. In accordance with an embodiment of the invention and as will be explained in more detail, the rules are used to determine whether use of the payment device (e.g., to make a purchase of a good or service) will be subjected to authentication (verification, validation) using a one-time-use CVV2 value. In some embodiments, if a transaction matches or satisfies the rule(s), then the transaction is authenticated using a one-time-use CVV2 value. If the transaction does not qualify under the rules (i.e., does not match the rules), then the transaction can be authenticated using the printed CVV2 code that is provided on the payment device. In either case, the transaction is rejected if the authentication fails and continues for approval (via an Authorization transaction, for example) if the authentication passes. Further details of this aspect of embodiments of the invention are discussed below.

Following is an illustrative sampling of rules which trigger the application of the one-time-use CVV2 service to authenticate a transaction:
amount threshold—The cardholder might specify a rule whereby the one-time-use CVV2 service is triggered (i.e., used to authenticate the transaction) when the transaction amount exceeds a certain dollar (or other monetary denomination) amount; for example, transactions above $200.
Merchant Category Codes (MCC)—The cardholder might specify certain MCC's to trigger the one-time-use CVV2 service. Thus, transactions involving all high-risk merchant categories may be selected or the selection could be more specific (e.g., electronics). The cardholder might be presented with meaningful descriptions of such merchant categories, rather than the actual codes, which can then be mapped to appropriate MCCs.
merchant location—The cardholder may specify that transactions with merchants in a certain location (e.g., outside of the country where the payment device was issued) will trigger the one-time-use CVV2 service.
transaction type—Certain transaction types can be specified by the cardholder as triggering the one-time-use CVV2 service; for example, ECMOTO (electronic commerce mail order telephone) transactions.
Accumulative Amount Threshold—The cardholder might specify a rule whereby the one-time-use CVV2 service is triggered if the total amount of multiple transactions exceeds a certain dollar amount, (e.g., $1,000) within specified timeframe (e.g., a month). In embodiment, a manager can limit the amount of money that can be spent on a “P-Card” (purchasing card, a form of company charge card) by an employee to prevent abuse. If there is a purchase required above the specified limit, the manager should be the only person with access to this service so that only the manager can obtain the one-time-use CVV2 value).
Velocity—This is an idea similar to the accumulative amount threshold, where, the cardholder can specify a maximum number of transactions allowed within specified timeframe (e.g., per month). This can be useful in situations when the cardholder uses a card only for his recurring payments (e.g., monthly bills) so that number of transactions a month is known.
Same MCC Velocity—This idea is a refinement of “velocity” where the cardholder can specify a maximum number of transactions for the same Merchant Category Code (MCC) to be allowed within specified timeframe (e.g., per month).

It can be appreciated from the foregoing that still other rules can be defined. The rules establish a threshold, and unless that threshold is crossed a transaction will not be authenticated using the one-time-use CVV2 service. For example, the cardholder might use his payment device to pay a monthly fee of $20 to an Internet provider for Internet service. For this transaction, the cardholder may not want to invoke (trigger) the one-time-use CVV2 service every month to pay the Internet service fee. The cardholder can define a rule that only transactions above $20 will invoke the one-time-use CVV2 service, thus providing convenience to the cardholder in that his monthly Internet fees need not require obtaining a one-time-use CVV2 value each time a payment is attempted.

The rules can include relational operators (“<”, “>”, “=”, “≦”, and so on) to define relational terms (e.g., purchase amount>$50). The rules can include logical operators (AND, OR, NOT, and so on) to form a comprehensive set of conditions with relational terms (e.g., purchase amount>$50 AND MCC type=“electronics”) as the criteria for triggering the one-time-use CVV2 service to authenticate a transaction. An embodiment of the invention can include a user interface that displays drop down menus to assist the cardholder in constructing or otherwise specifying the rules.

Continuing with FIG. 2, when the cardholder has completed inputting the information, the collected information can be stored by the payment processing organization 100. At branch point 201 in the flow shown in FIG. 2, if the cardholder signed up using an issuer provided service (e.g., issuer's website, issuer' ATM machine, etc.), then in step 206 the information collected by the issuer 142 is uploaded to the payment processing organization's enrollment server 124 through a secure connection.

In step 208, the enrollment server 124 can process the cardholder registration information, whether received directly from a cardholder as in the case of cardholder 102b, or from the issuer 142 as in the case of cardholder 102a, and pass it to the payment processing system 122. The cardholder's profile information, which includes any cardholder-defined rules for triggering the one-time-use CVV2, can be stored in the cardholder database (CDB) 136 or other suitable data storage system that is maintained by the payment processing system 122.

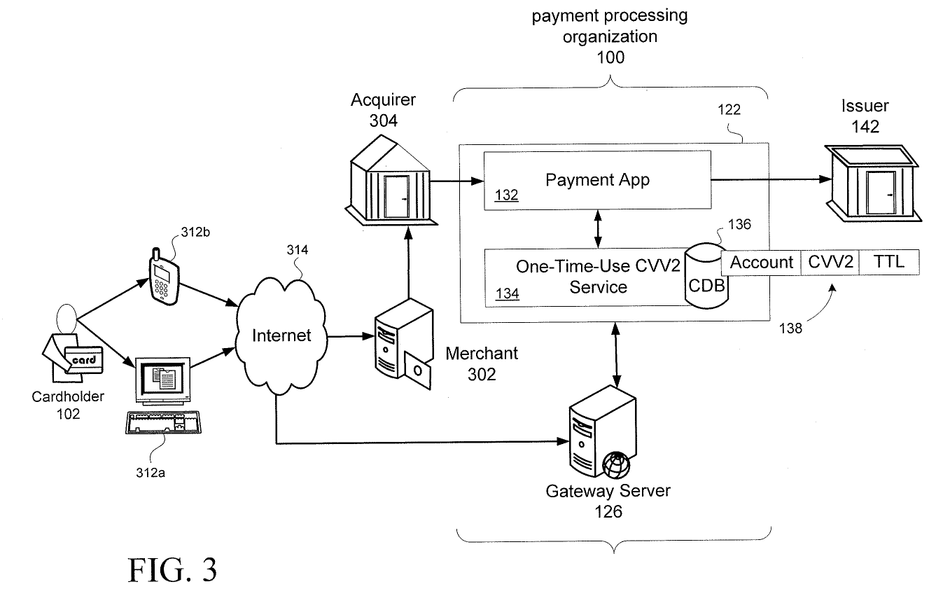

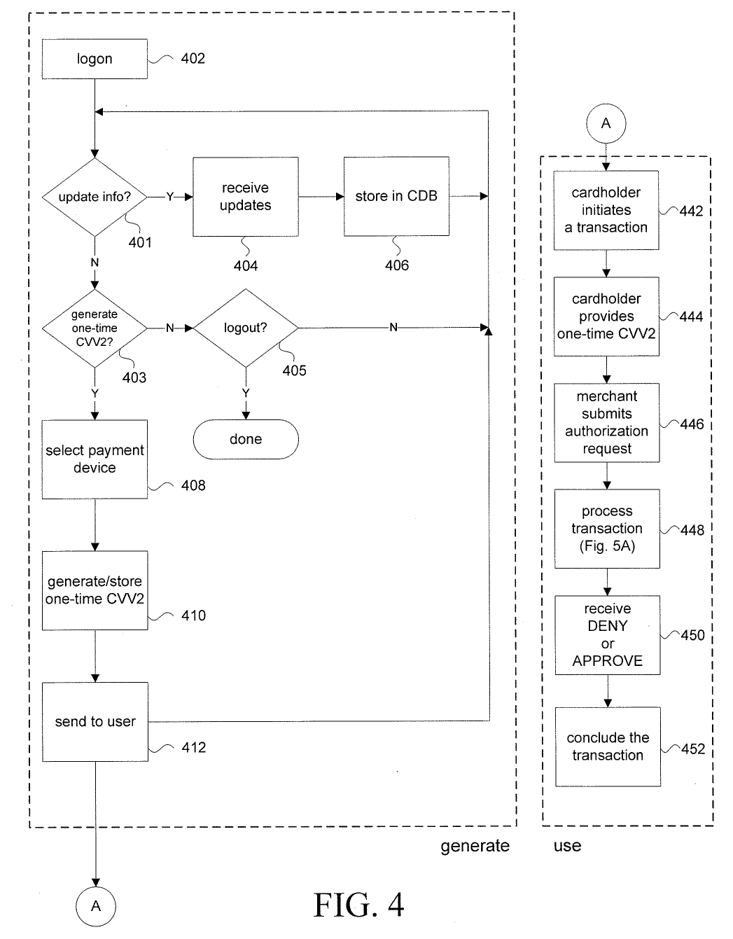

FIGS. 3 and 4 illustrate the flow for a transaction in accordance with embodiments of the invention. The block diagram in FIG. 3 shows a user 102 interacting with a suitable computing device such as a personal computer 312a or a mobile device 312b over a communication network 314. In an embodiment of the invention, the communication network 314 includes the Internet. A gateway server 126, managed and operated by the payment processing organization 100, is accessible by the cardholder 102 via the communication network 314. An online merchant 302 is also accessible by the cardholder 102 via the communication network 314. An acquirer 304 maintains a relationship with the online merchant 302 for the purpose of acceptance, clearing, and settlement of the online merchant's credit or debit card sales.

When a cardholder 102 has registered with the payment processing organization 100, the cardholder can log into the gateway server 126 using a login ID and password created during the registration process to manage his profile information. Referring to FIG. 4, at step 402 the cardholder 102 can log onto the gateway server 126 using a browser on the cardholder's computer 312a or mobile device 312b, or through a password protected application installed on the mobile device. The connection can be encrypted, e.g., using SSL 3.0. In an embodiment, a suitable user interface can be presented to the cardholder 102 providing the cardholder with a list of options. Administrative options can include, at branch point 401, allowing the cardholder 102 to manage his cardholder profile information (steps 404, 406), including such actions as updating his personal information, account information (e.g., account number, address, etc.) for each payment device, add or delete payment device accounts, and so on. Another option, at branch point 405, allows the cardholder 102 to logout out of the gateway server 126.

The cardholder 102 can conduct a transaction in accordance with an embodiment of the invention. Suppose, for example, the cardholder 102 desires to make an online purchase of an item from the online merchant 302. The cardholder 102 can proceed to branch point 403 in the flow shown in FIG. 4 to begin the process of generating a one-time-use CVV2 value in accordance with an embodiment of the invention.

At step 408, the cardholder 102 can request a one-time-use CVV2 value to be generated for his payment device. Alternatively, the cardholder 102 can be presented with a list of account numbers if he has more than one payment device associated with his profile. In the case of multiple payment devices, the cardholder 102 can be given the option to identify one payment device from the list for which a one-time-use CVV2 value will be generated. The cardholder 102 can be allowed to identify more than one payment device from the list, in which case a one-time-use CVV2 value will be generated for each identified payment device. Whether the cardholder 102 is allowed to generate more than one one-time-use CVV2 value or not can be controlled by policies of the payment processing organization 110 or can be an option that the cardholder elected during the registration process.

At step 410, one or more one-time-use CVV2 values can be generated. The gateway server 126 connects to the payment processing system 122 to request one or more one-time-use CVV2 values using the information collected from the cardholder 102 by the gateway server 126 in step 408. More specifically, the one-time-use CVV2 service component 134 receives the request to generate the one or more one-time-use CVV2 values. For each payment device specified by the cardholder for which a one-time-use CVV2 value is to be generated, the one-time-use CVV2 service component 134 can use algorithms provided by the corresponding issuer of the payment device to generate the one-time-use CVV2 value. Alternatively, the payment processing organization 100 can develop and use its own algorithms to generate one-time-use CVV2 values.

In accordance with an embodiment of the invention, a generated one-time-use CVV2 value is stored with or otherwise associated with the profile information of the cardholder 102 and in particular is associated with the account number of the cardholder's payment device for which the one-time-use CVV2 value was generated. An illustrative embodiment is shown in FIG. 3 where the CDB 136 is shown storing a data record 138 for a payment device; one such data record can be provided for each payment device. The data record 138 can include an “account” field that stores an account number of the payment device. In an embodiment, the payment device can be a credit card and the account number can be the primary account number (PAN) of the credit card. The data record 138 can include a “CVV2” field that stores the one-time-use CVV2 value generated for the payment device. The data record 138 can include a “TTL” field to store a TTL (time to live) that is associated with the generated one-time-use CVV2 value. The data record 138 can include a time value indicating a time when the one-time-use CVV2 value was generated or sent to the cardholder or the like.

In accordance with embodiments of the invention, a TTL can be generated for each one-time-use CVV2 value. In accordance with embodiments of the invention, the one-time-use CVV2 value has a limited lifetime, indicated by the TTL. In an embodiment, the one-time-use CVV2 value must be used before the end of the TTL period. If an attempt is made to use the one-time-use CVV2 value in a transaction made subsequent to expiration of the TTL period, then that transaction can be rejected.

The TTL can be expressed in any of several ways. The payment processing system 100 can provide a policy whereby a predetermined TTL is defined for all one-time-use CVV2 values. The TTL can be specified by the cardholder 102, though to increase effectiveness of the one-time-use CVV2 value, the payment processing system 122 may impose a limit on the maximum value that the cardholder 102 can assign to the TTL in order to avoid the cardholder inadvertently specifying too long of a period and thus increase exposure to the risk of fraudulent use.

The TTL can represent a duration of time (e.g., 10 minutes, 23 minutes, one hour, and so on), or the TTL can represent an absolute time. For example, suppose a request for a one-time-use CVV2 value was made at 10:30 AM on Oct. 23, 2010, the TTL can designate 1:35 PM on that day as the time limit for when the one-time-use CVV2 value must be used. Similarly, the TTL can specify a different day and time (e.g., 2 PM, Oct. 25, 2010) for when the one-time-use CVV2 value must be used. Alternatively, the payment processing organization 100 can institute a policy of always assigning a predetermined duration for the TTL (e.g., the code is valid for a period of 30 minutes), or may present the cardholder 102 with a list of predefined TTL durations from which a selected TTL can be chosen, and so on. The cardholder 102 may predefine one or more TTL values in his profile from which a selected TTL can be chosen. These and any other alternatives can be used to specify a suitable TTL.

The time period of the TTL can begin about the time when the one-time-use CVV2 value is generated or communicated (step 412) to the cardholder 102, and ends at a later point in time as explained above. In an alternative embodiment, the TTL time period can begin at some point in time after the one-time-use CVV2 value is given to the cardholder 102. For example, the start time of the TTL time period might be two hours from the time of issuance of the one-time-use CVV2 value, so that the one-time-use CVV2 value is not activated for two hours (i.e., the one-time-use CVV2 value cannot be used to make a purchase for two hours). Alternatively, an absolute time can be specified; for example, the TTL time period starts at 2:30 PM the next day.

Returning to FIG. 4, at step 412 the one or more generated one-time-use CVV2 values can be communicated to the cardholder 102 for subsequent use. The one or more generated one-time-use CVV2 values can be sent from the one-time-use CVV2 service component 134 directly to the cardholder 102, or the one-time-use CVV2 service component can provide the one or more generated one-time-use CVV2 values to the gateway server 126 which in turn communicates the information to the cardholder.

Communication of the one or more one-time-use CVV2 values can be accomplished by the gateway server 126 presenting them on the web page that is being displayed on the cardholder's computer 312a. The one or more generated one-time-use CVV2 values can be emailed to an email account of the cardholder 102. The one or more generated one-time-use CVV2 values can be emailed or texted to the mobile device 312b of the cardholder 102. It will be understood, that any one or more of these and other suitable forms for communicating the one or more generated one-time-use CVV2 values to the cardholder 102 can be used.

When the cardholder 102 has received his one-time-use CVV2 value(s) from the gateway server 126, the cardholder can logout of the gateway server 126 and subsequently conduct a transaction that triggers the use of a one-time-use CVV2 value. An example of such a transaction is an online purchase of goods or services which is illustrated in FIG. 4 by the steps following step 412 indicate by the connector A.

In step 442 the cardholder 102 can initiate an online purchase transaction using a web site hosted by the merchant 302. It will be appreciated of course that the transaction need not be an online purchase. During the normal course of conducting a purchase with a consumer, the merchant 302 can ask the cardholder 102 for a CVV2 value.

In step 444, the cardholder 102 can provide the merchant 302 with either the CVV2 value that was pre-printed on the payment device (the printed CVV2 code) or the one-time-use CVV2 value obtained from the payment processing organization 100 as explained above. The cardholder 102, knowing that he is conducting a transaction for which the one-time-use CVV2 value is required should provide the obtained one-time-use CVV2 value to the merchant 302.

In step 446, the merchant 302 can submit an authorization request to obtain authorization in order to proceed with the purchase transaction by sending the authorization request to the acquirer 304. The authorization request includes, among other conventionally provided information, information about the received CVV2 code provided by the cardholder 102 in step 444 and information about the transaction such as the account number of the payment device, the amount of the transaction and the like.

The authorization request to authorize the purchase transaction is received by the acquirer 304. The authorization request can be forwarded by the acquirer 304 to the payment processing system 122 to process the authorization request in accordance with an embodiment of the invention, step 448. Additional details of this step will be discussed below.

An authorization code is produced as a result of the processing that occurs in step 448. In step 450, the authorization code can be communicated back to the merchant 302. The merchant 302, in step 452, can then conclude the purchase transaction accordingly based on the received authorization code. For example, if the authorization code is DENIED, then the merchant 302 can simply refuse to sell the cardholder 102 the goods or services that are the subject of the purchase transaction. On the other hand, if the authorization code is APPROVED, then the merchant 302 can proceed with its normal course of completing the sale of the goods or services with the cardholder 102.

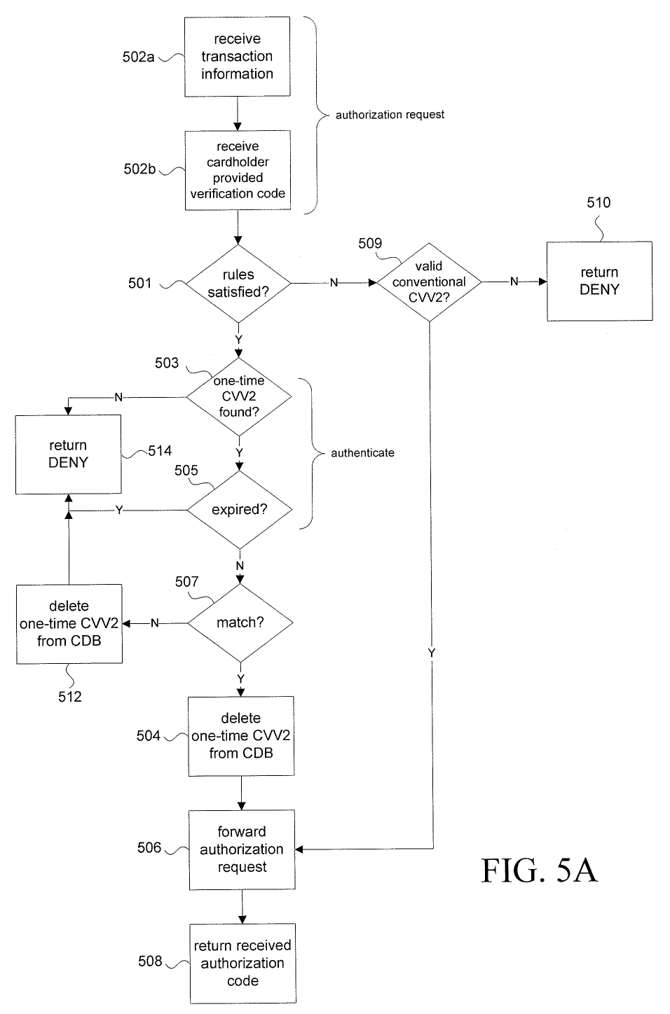

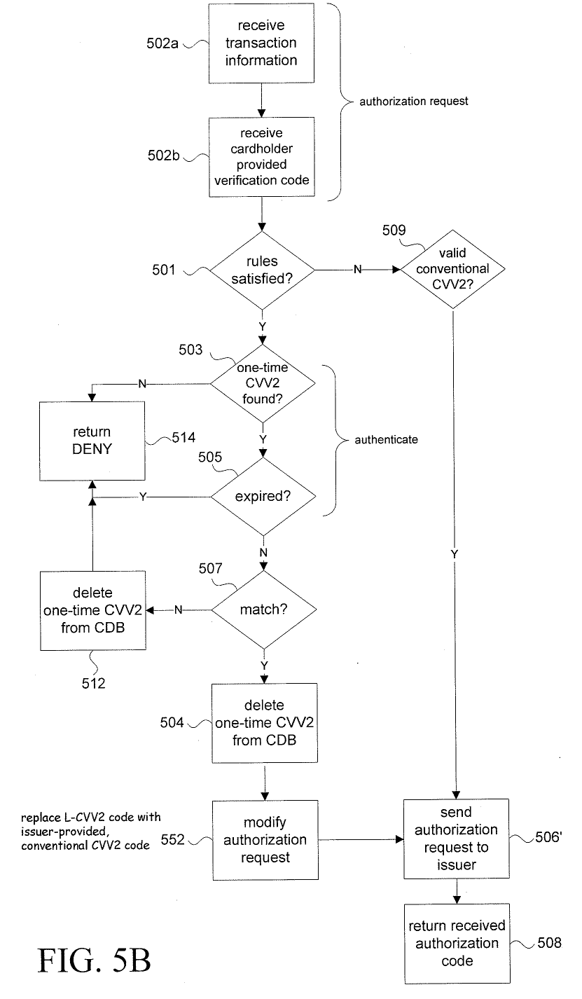

Refer now to FIGS. 3 and 5A for a discussion of an embodiment of transaction processing in accordance with the invention. According to an embodiment, if the transaction matches the cardholder's rules, then the transaction must be authenticated using a one-time-use CVV2 value generated as described above. If the transaction does not match the cardholders' rules, the transaction can be authenticated using the printed CVV2 code printed on the payment device. The following discussion of FIG. 5A describes this embodiment in further detail.

Recall in step 448, the payment processing system 122 may receive the authorization request from the acquirer 304 to authorize the purchase transaction initiated in step 442. Handling of the authorization request continues with FIG. 5A. Thus, in steps 502a and 502b the payment application component 132 can receive the authorization request which includes the received CVV2 code provided by the cardholder 102 in step 444 and information about the transaction.

In decision step 501, the payment application component 132 can determine if the transaction matches the one or more rules associated with the account number of the payment device used to make the transaction. For example, the payment application component 132 can obtain the account number of the payment device used to make the transaction. Using the account number and interacting with the one-time-use CVV2 service component 134, a comparison can be made of the parameters of the transaction and one or more rules defined by the cardholder 102 to authenticate the transaction.

If there are no rules, then the outcome of decision step 501 is N (no). Likewise, if there are rules and the parameters of the transaction do not match the rules, then the outcome of the decision step 501 is also N. The flow then proceeds to a decision step 509, where the transaction is authenticated based on the CVV2 code printed on the payment device. In an embodiment, the payment processing system 122 can be provided with and maintain the encryption key and the algorithm that each issuer of a payment device uses to generate the printed CVV2 code. The payment processing system 122 can therefore generate the printed CVV2 code on the fly, without having to store it anywhere. More specifically, if the received CVV2 code does not match the generated printed CVV2 code, then the authentication has failed, there is no need to further process the authorization request, and an authorization code of DENY is sent to the acquirer 304 in step 510.

If, on the other hand, the received CVV2 code does match the stored printed CVV2 code, then the authorization request can be handled in the normal course for processing an authorization request, namely, the authorization request can be forwarded by the payment processing system 122 in step 506 to the issuer 142. The issuer 142 makes a decision whether to APPROVE or DENY the authorization request and sends an appropriate authorization code to the payment processing system 122. The payment processing system 122 can send, in step 508, the received authorization code to the acquirer 304.

Returning to decision step 501, if the cardholder 102 had defined one or more rules and the parameters of the transaction match the rules, then the outcome of the decision step 501 is Y (yes). Thus, for example, suppose the rules comprise the following:
1. “greater than $200 and MCC type is “electronics” OR
2. “greater than $500 and country of merchant is Canada”, then a transaction for the purchase of a $400 electronic device from a U.S. merchant would satisfy rule 1. When the transaction matches one or more of the rules, then in an embodiment of the invention, the transaction must be authenticated using a one-time-use CVV2 value that is associated with the payment device used to initiate the transaction.

The flow, accordingly, proceeds to decision step 503, where the payment application component 132 can operate in conjunction with the one-time-use CVV2 service component 134 to make a determination whether or not there is a one-time-use CVV2 value associated with the payment device that was used to initiate the transaction. The determination can be made in any of numerous ways and will depend on the specific embodiment of the invention. For example, in the embodiment shown in FIG. 3 the data record 138 corresponding to the payment device used to initiate the transaction can be inspected. If the data record 138 is not found, its absence could serve to indicate that a one-time-use CVV2 value is not associated with the payment device. This embodiment offers the benefit of storage efficiency since the cardholder database 136 does not need to store unused data records. If in an embodiment where for some reason a data record 138 is always maintained, a convention of filling the “CVV2” field in the data record with zeroes can be used to indicate that a one-time-use CVV2 value is not associated with the payment device. In still another embodiment where there is always a data record 138, a flag can be set to specific states (e.g., “1”, or “0”) to indicate whether or not a one-time-use CVV2 value is associated with the payment device. Still other known software programming techniques can be used to indicate whether or not a one-time-use CVV2 value is associated with the payment device.

Returning to FIG. 5A, processing proceeds from decision step 503 to step 514 where an authorization code of DENY can be sent to the acquirer 304 if it is determined that a one-time-use CVV2 value is not associated with the payment device. On the other hand, processing proceeds to decision step 505 if it is determined that there is a one-time-use CVV2 value associated with the payment device, in which case the one-time-use CVV2 value will be stored in the data record 138 corresponding to the payment device used to make the transaction.

Decision step 505 determines whether or not the one-time-use CVV2 value has expired. This determination can be made by using a time associated with the transaction and the TTL stored in the “TTL” field of the data record 138 corresponding to the payment device that was used to make the transaction. The specifics of making the determination will depend on the nature of the TTL. For example, in an embodiment of the invention the TTL specifies a duration, say 15 minutes. If the time of transaction is within 15 minutes of the time when the one-time-use CVV2 value was generated, then the one-time-use CVV2 value can be deemed not to have expired; the one-time-use CVV2 value can be deemed to have expired, otherwise.

If the one-time-use CVV2 value is deemed not to have expired, then processing proceeds to decision step 507. At this point, the transaction is deemed to have matched one or more of the rules defined by the cardholder 102, and so the transaction must be authenticated with a one-time-use CVV2 value. Also at this point, it has been determined that there is a one-time-use CVV2 value that has not expired. In decision step 507, the one-time-use CVV2 value stored in the data record 138 corresponding to the payment device used to make the transaction is compared with the received CVV2 code provided by the cardholder 102 contained in the authorization request.

A non-match can be taken to mean that the transaction is not authenticated, and processing can proceed to step 512. This step will be explained in conjunction with the discussion of step 504 below. In step 514, a DENY authorization code can be sent to the acquirer 304 to indicate that the transaction has not been authenticated.

A match can be taken to mean that the transaction is authenticated, and processing can proceed to step 504. An aspect of embodiments of the invention is that the one-time-use CVV2 value is used only once. Accordingly, in step 504, after the transaction has been authenticated by the one-time-use CVV2 value, it can deleted from the data record 138 (e.g., the data record is filled with zeroes) to indicate that the corresponding payment device no longer is associated with the one-time-use CVV2 value. In another embodiment, a flag can be set to a predetermined state to indicate that the one-time-use CVV2 value has been used to authenticate a transaction.

Thus, decision steps 503 and 505 determine that a valid one-time-use CVV2 value exists before it is used to authenticate a transaction; i.e., the one-time-use CVV2 value has not been previously used to authenticate a transaction and it has not expired. Step 504 assures that the one-time-use CVV2 value is used only once to authenticate a transaction. In the case of step 504, the transaction was successfully authenticated. However, in the case where authentication of the transaction has failed, it may still be desirable to delete the one-time-use CVV2 value. Therefore, the N branch in decision step 507 (failed authentication) flows to step 512, where like step 504, the one-time-use CVV2 value can be deleted from the data record 138. Accordingly, the one-time-use CVV2 value is used only once irrespective of whether or not the transaction is successfully authenticated.

Continuing from step 504, at this point the transaction has been successfully authenticated. In accordance with an embodiment of the invention conventional processing of the transaction can be performed to process the authorization request. In an embodiment, for example, the payment processing system 122 can forward the authorization request in step 506 to the issuer 142. The issuer 142 can perform its normal processing to handle authorization requests to produce a DENY or APPROVE authorization code. The authorization code can be sent to the payment processing system 122, where in step 508 the received authorization code is sent to the acquirer 304 (which in turn will forward it to the merchant, see step 450, FIG. 4).

The issuer 142 develops and uses its algorithms to generate CVV2 codes for its payment devices. In an embodiment, the payment processing system 122 stores the algorithms needed for CVV2 generation for each issuer 142. Therefore, the payment processing system 122 can perform the CVV2 authentication on behalf of the issuers 142. However, some issuers 142 require their own CVV2 authentication. In such cases, the CVV2 authentication is performed by the issuer 142 rather than by the payment processing system 102, and in particular the issuer will authenticate the transaction using the printed CVV2 code that the issuer had generated and printed on the payment device.

FIG. 5B illustrates an embodiment in which a transaction can be authenticated using a one-time-use CVV2 values of the invention as well as the printed CVV2 code. Steps shown in FIG. 5B that are common to steps in FIG. 5A are referenced with the same reference numerals and have the same descriptions. Explanation of the processing shown in FIG. 5B picks up with step 552.

By the time processing reaches step 552, the transaction for which the authorization is being requested will have been determined to match one or more of the rules defined by the cardholder 102 (step 501). A determination will have been made that the transaction has been authenticated in accordance with an embodiment of the invention using the generated one-time-use CVV2 value (steps 503, 505, 507). More specifically, the CVV2 code received in the authorization request has been determined to match with the one-time-use CVV2 value stored in the data record 138 corresponding to the transaction for which authorization is being requested. At this point, the authorization request can be sent to the issuer 142 for further processing. However, in the embodiment of FIG. 5B, the issuer 142 conducts its own authentication in addition to its normal task of handling the authorization request; and more particularly, the issuer 142 conducts the authentication using the printed CVV2 code that the issuer had generated.

In step 552, the authorization request received by the payment processing system 122 can be modified to replace the received CVV2 code. In an embodiment, the payment processing system 122 can be provided with and maintain the encryption key and the algorithm that each issuer of a payment device uses to generate the printed CVV2 code. More specifically, the payment application component 132 can operate in conjunction with the one-time-use CVV2 service component 134 to generate a copy of the CVV2 code that is printed on the payment device that was used to make the transaction and replace the received CVV2 code in the received authorization request with the generated printed CVV2 code.

In step 506′, the modified authorization request can then be sent to the issuer 142. The issuer 142 can perform its normal processing to handle authorization requests to produce a DENY or APPROVE authorization code. The authorization code can be sent to the payment processing system 122, where in step 508 the received authorization code is sent to the acquirer 304 (which in turn will forward it to the merchant, see step 450, FIG. 4).

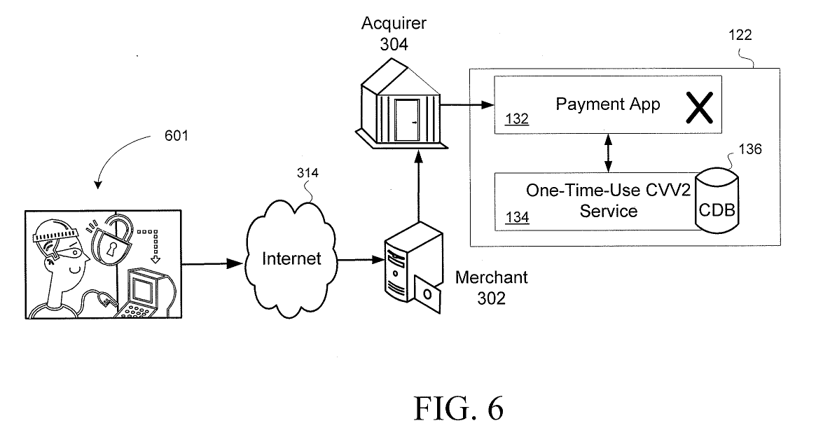

FIG. 6 in conjunction with FIG. 5A illustrates an exception flow using the one-time-use CVV2 value of embodiments of the invention:
1) A person 601 attempting to commit fraud initiates a card-not-present purchase using stolen information which includes a CVV2 value from the back of the card. The card itself may have been stolen, or card information may have been copied at a restaurant or intercepted at a compromised merchant website, etc.
2) The payment processing system 122 checks (step 501) if the submitted transaction matches rules previously defined by the cardholder 102 (e.g., the rule might be a transaction amount). The payment processing system 102 also checks to see if the one-time-use CVV2 value was used (step 503 in conjunction with step 504), or has expired (step 505).
3) The payment processing system 122 determines that the one-time-use CVV2 values was not used (or, the one-time-use CVV2 value has expired) in this example, and sends a DENY authorization code. This may indicate that the current transaction that is being conducted is fraudulent, and so the merchant 302 rejects the transaction.

Embodiments of the invention provide several advantages. For example, embodiments of the invention provide a cardholder with a one-time-use CVV2 value, namely a temporary security value, in real time upon request. The security value can be “short-lived”, e.g., it will have to be used by the cardholder within a predetermined number of minutes (e.g., 5 minutes). Thus, even if it is stolen or otherwise obtained without permission, the security value will likely have expired by the time the unauthorized possessor uses it.

Security values in accordance with embodiments of the invention can only be used once, so that an unauthorized user is limited in the amount of financial damage that can be caused.

Security values in accordance with embodiments of the invention can be selectively required based on one or more aspects of the transaction, using one or more rules defined by the cardholder. For example, this can provide an added measure of security against fraud for “large” dollar item transactions, while at the same time allow small dollar amount transactions to proceed without the need for the security values.

An embodiment of the invention allows the payment processing system to employ a temporary security value to detect fraudulent use while at the same time conforming to the issuer's requirement that the issuer performs it own authentication using its own security value.

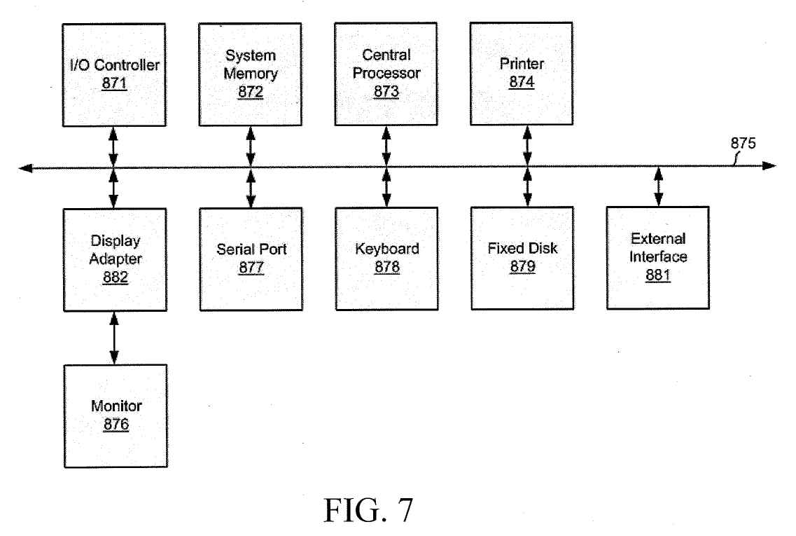

Any of the entities or components described above may include one or more of the subsystems or components shown in FIG. 7, which is a block diagram of a computer apparatus. The subsystems shown in the figure are interconnected via a system bus 875. Additional subsystems such as a printer 874, keyboard 878, fixed disk 879, monitor 876, which is coupled to display adapter 882, and others are shown. Peripherals and input/output (I/O) devices, which couple to I/O controller 871, can be connected to the computer system by any number of means known in the art, such as serial port 877. For example, serial port 877 or external interface 881 can be used to connect the computer apparatus to a wide area network such as the Internet, a mouse input device, or a scanner. The interconnection via system bus allows the central processor 873 to communicate with each subsystem and to control the execution of instructions from system memory 872 or the fixed disk 879, as well as the exchange of information between subsystems. The system memory 872 and/or the fixed disk 879 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method comprising:
selecting one or more conditions under which a temporary security value will be used in a transaction;
receiving the temporary security value from a remote server computer; and
conducting a transaction using the temporary security value when the transaction matches one or more of the conditions.

2. The method of claim 1 further comprising associating an expiration time with the temporary security value, wherein the temporary security value is valid only for a transaction made prior to expiration of the expiration time.

3. The method of claim 1 wherein the temporary security value is valid for making exactly one transaction.

4. A computer readable storage medium having stored thereon computer executable code which when executed by a server computer cause the server computer to perform the method of claim 1.

5. A payment processing system comprising one or more computer systems, at least one of the computer systems comprising the computer readable storage medium of claim 4.

6. A method comprising:
receiving one or more selected conditions under which a temporary security value will be used in a transaction;
receiving an authorization request message including the temporary security value at a server computer, wherein the authorization request message requests authorization for the transaction;
using the server computer, authenticating the authorization request message using the temporary security value and the one or more selected conditions; and
sending an authorization response message, wherein the authorization response message indicates approval or denial of the transaction, wherein the transaction is denied if the one or more conditions are not satisfied, wherein a determination is made whether to approve or deny the transaction if the one or more conditions are satisfied.

7. A method:
receiving an authorization request message for a transaction from a merchant and at a server computer, wherein the authorization request message includes a received verification value and transaction information;
authenticating the transaction using the transaction information, the received verification value and one or more rules; and
sending an authorization response to the authorization request message using the server computer,
wherein the transaction is (i) authenticated if the transaction information does not satisfy the one or more rules, (ii) not authenticated if the received verification value is a first verification value and the transaction satisfies the one or more rules, and (iii) authenticated if the received verification value is a second verification value and the transaction satisfies the one or more rules.

8. The method of claim 7 wherein the second verification value is valid when the second verification value has not been used to authenticate a previous transaction.

9. The method of claim 7 wherein validity of the second verification value is based on a time of receipt of the authorization request message and a start time associated with the second verification value.

10. The method of claim 9 wherein the second verification value is generated in response to a request from a user and the start time is based on a time when the second verification value was generated.

11. The method of claim 7 wherein the first and second verification values are associated with a portable consumer device, wherein the first verification value is determined at a time of issuance of the portable consumer device and the second verification value is determined at a time subsequent to issuance of the portable consumer device.

12. The method of claim 11 wherein the first verification value is printed on the portable consumer device and the second verification value is not printed on the portable consumer device.

13. The method of claim 7 wherein the one or more rules are provided by a user making the transaction.

14. The method of claim 7 wherein the first and second verification values are associated with a portable consumer device and the transaction is a card-not-present transaction.

15. The method of claim 7 wherein the first and second verification values are associated with a portable consumer device, wherein the authentication is performed by an issuer of the portable consumer device.

16. A computer readable storage medium having stored thereon computer executable code which when executed by a server computer cause the server computer to perform the method of claim 7.

17. A payment processing system comprising one or more computer systems, at least one of the computer systems comprising the computer readable storage medium of claim 16.
